(19) United States
(12) Patent Application Publication
(10) Pub. No.: US 2007/0272134 A1
(43) Pub. Date: Nov. 29, 2007

(54) Ground opening device

(76) Inventors: Christopher John Baker, Feilding (NZ); William Rowlan Ritchie, Feilding (NZ); David John Robinson, Palmerston North (NZ)

Correspondence Address: ABELMAN, FRAYNE & SCHWAB, 666 THIRD AVENUE, 10TH FLOOR, NEW YORK, NY, 10017, US

(21) Appl. No.: 11/440,176

(22) Filed: May 23, 2006

(51) Int. Cl. A01C 5/00

(52) U.S. Cl. 111/163

(57) ABSTRACT

A ground opening device includes a ground-penetrating element configured to penetrate a ground surface, a down drive element configured to apply a downward force to the ground-penetrating element, a reaction force sensor configured to sense a ground reaction force in response to the action of the ground-penetrating element, and a controller configured to adjust the downward force on the ground-penetrating element in response to the sensed ground reaction force.

### TECHNICAL FIELD

This invention relates to a ground opening device.

### BACKGROUND ART

Modern agricultural methods commonly involve the planting of large areas of ground with the same crop. In such instances the ideal situation, from a crop management viewpoint, is for all the plants in the crop to grow at the same rate so that the entire crop can be treated as though it were a single plant.

The key to this is consistent seed germination and seedling emergence for all plants in the crop. This requires that seeds must be sown at a consistent depth in the soil. When seeds are sown individually by hand this is not a significant problem. However, it can be a problem when, as is commonly the case, the seeds are sown mechanically.

Any large area of ground (plot) for seeding is likely to contain a range of soil conditions. The composition or type of soil may change, as may the soil moisture content and degree of compaction. These and other factors can influence the resistance of the soil to penetration by the seeding apparatus. Therefore, a seeding machine set to sow seeds at a particular depth in one region of the plot may not sow at the same depth in another region, leading to variations in seed germination and seedling emergence.

Tillage of soil, for example by ploughing, has the effect of breaking up and loosening the soil. It may also produce greater homogeneity of the soil by mixing soil from surrounding areas together. Tilled soils are often leveled to some extent, commonly by use of a harrow or some form of raking of the soil surface, prior to seeding.

Typically a seed drill opener, towed behind a tractor or other mechanised farm vehicle is then used to plant the seed. A seed drill opener will usually have one or more opening devices, such as discs, blades, knives or tines, to open a slot in the ground. The depth of the slot, and in turn the depth of planting of the seed, is then determined by the amount of force applied downwardly onto the opening device.

If the soil has been loosened by tillage, springs of various types may be sufficient to provide the necessary downward force and to allow the opening device to rise and fall in response to small changes in the surface topology.

Generally the downward force on the opening device is increased until the desired depth of penetration is achieved. Further penetration is usually prevented by use of a depth-limiting device, such as a gauge wheel, which is rigidly attached to the opening device. The gauge wheel is adjusted to sit on the surface of the ground when the opening device is at the required depth, thus preventing the opening device from being lowered beyond that point.

In practice an additional load may be placed onto the opening device in order to compensate for small variations in soil conditions.

A disadvantage with this method is that the amount of additional force required is a matter of judgement and therefore consistency of depth penetration over the whole plot cannot be assured

While an effect of tilling and harrowing of the soil is to reduce the variability of the soil conditions over the plot, nevertheless variations will remain and some inconsistency of depth for seeding can occur.

Increasingly, moreover, the practice of tillage of soils is being considered less desirable. Not only is it expensive and time consuming, but also in many regions it is believed to be contributing to degradation of the environment through increased rates of soil erosion, loss of soil moisture content and leaching of essential minerals and nutrients from the opened soil.

In such regions the seeds are planted directly into non-tilled ground. In non-tillage applications the concept is to limit or minimise the disturbance of the surface and the soil. Generally plant and other material on and above the surface is left intact, removed or reduced without disturbing the surface if possible. The seeds can then be planted using a seed drill opener adapted for use in non-tilled soils.

Aspects of seed drill openers and their use in non-tilled soils are disclosed in U.S. Pat. No. 4,275,671, U.S. Pat. No. 5,269,237 and U.S. Pat. No. 6,644,226.

Drill seed openers for use in non-tilled soil must cope with greater variations in the force required to penetrate the soil and surface material than in the case of tilled soil.

Firstly the force required to penetrate non-tilled ground will in general be greater than the force required to penetrate the same ground that has been loosened by tillage.

Secondly, the variability of soil conditions has not been ameliorated by tillage.

Thirdly, there are likely to be greater surface irregularities in non-tilled soils, as tilling and harrowing will not have leveled these out.

Therefore the seed drill opener operating in non-tilled soil must use larger forces and cope with greater variation in conditions than in tilled soil.

A problem with the current operation of a seed drill opener is that there is no way of compensating for all variations of soil conditions even in tilled soils. This is a much greater problem for seeding in non-tilled soils, where the forces and variations in conditions are much greater.

It is an object of the present invention to address the foregoing problems or at least to provide the public with a useful choice.

All references, including any patents or patent applications cited in this specification are hereby incorporated by reference. No admission is made that any reference constitutes prior art. The discussion of the references states what their authors assert, and the applicants reserve the right to challenge the accuracy and pertinency of the cited documents. It will be clearly understood that, although a number of prior art publications are referred to herein, this reference does not constitute an admission that any of these documents form part of the common general knowledge in the art, in New Zealand or in any other country.

It is acknowledged that the term ‘comprise’ may, under varying jurisdictions, be attributed with either an exclusive or an inclusive meaning. For the purpose of this specification, and unless otherwise noted, the term ‘comprise’ shall have an inclusive meaning—i.e. that it will be taken to mean an inclusion of not only the listed components it directly references, but also other non-specified components or elements. This rationale will also be used when the term ‘comprised’ or ‘comprising’ is used in relation to one or more steps in a method or process.

Further aspects and advantages of the present invention will become apparent from the ensuing description which is given by way of example only.

### DISCLOSURE OF INVENTION

According to one aspect of the present invention there is provided a ground opening device which includes,

a ground-penetrating element configured to penetrate a ground surface,
a down drive element configured to apply a downward force to the ground-penetrating element,
a reaction force sensor configured to sense a ground reaction force in response to the action of the ground-penetrating element,
characterised in that
the ground opening device includes a controller configured to adjust the downward force on the ground-penetrating element in response to the sensed ground reaction force.

According to another aspect of the present invention there is provided a method of controlling a ground opening device having a ground-penetrating element, a down drive element, a ground reaction force sensor and a controller,

characterised by the steps of
a) applying a downward force to the ground-penetrating element using the down drive element, and
b) sensing a ground reaction force using the ground reaction force sensor; and
c) using the controller to adjust the downward force of the ground-penetrating element in response to the sensed ground reaction force.

A ground-opening device may be considered to be any implement that breaks the surface of the ground and penetrates to some depth into the soil. Spades, forks, hoes and drills are all familiar ground opening devices in domestic gardening.

On a larger scale, as is common in modern agricultural practice, the ground opening device may be a plough or harrow, among others. Such ground-opening devices are used to prepare large areas of ground and numerous specialised devices have been constructed for this purpose.

In a preferred embodiment of the current invention the ground-opening device is a seed drill opener. Seed drill openers are devices used to open the ground and insert seeds, usually at a predetermined depth. Seed drill openers usually include a device for covering the implanted seed and closing the opening as part of the seeding operation. The seed drill opener is normally attached to a vehicle, such as a tractor, which pulls the seed drill opener over the ground.

Reference will be made throughout this specification to a ground-opening device being a seed drill opener. However, those skilled in the art will be aware that there are other forms of ground opening devices, such as ploughs, harrows and hoes among others, and that reference to a seed drill opener only should not be seen as limiting.

Seed drill openers are normally configured for a particular task. For example the design and operation of a seed drill opener will depend on such things as whether it is to be used on tilled or untilled ground, and the nature of the crop to be sown as different seeding depths may be required for different crops.

In a preferred embodiment of the current invention the ground-opening device is a seed drill opener for seeding non-tilled ground.

U.S. Pat. No. 4,275,671, U.S. Pat. No. 5,269,237 and U.S. Pat. No. 6,644,226 all disclose seed drill openers configured for use in non-tilled ground.

Reference will be made throughout this specification to a ground-opening device being a seed drill opener configured for seeding non-tilled ground. However, those skilled in the art will be aware that there are other forms of seed drill openers, such as those for use on tilled ground, and that reference to a seed drill opener configured for use on non-tilled ground only should not be seen as limiting.

While the current invention may be used to advantage with a wide range of ground opening devices, it is particularly advantageous (as will be outlined below) when used with a seed drill opener on non-tilled ground.

Proper germination of a seed depends, among other things like soil temperature and moisture, on the depth of planting of the seed. A seed drill opener must therefore provide a means of opening the ground to the required depth and implanting the seed.

Opening the ground is achieved by use of a ground-penetrating element. It is well known that practically any substantially rigid implement may be used to penetrate the ground, particularly if sufficient force is applied. However, in agriculture ground-penetrating elements are normally configured to achieve particular results depending on the task to be performed and the nature of the ground. Common examples of ground-penetrating elements used in agriculture include blades, knives, discs and tines, among others.

In a preferred embodiment of the current invention the ground-penetrating element includes a disc.

In an alternate embodiment of the current invention the ground-penetrating element includes a tine. The tine may be a rigid or non-rigid prong, often with a pointed end, which is pushed into the soil.

Reference will be made throughout this specification to a ground-penetrating element as including a disc. However, those skilled in the art will be aware that other forms of ground-penetrating elements, such as tines, knives or blades, could be included, (either alone or in combination with a disc or other such element), and that reference to the ground-penetrating element as including a disk only should not be seen as limiting.

Preferably substantially flat discs are used in seed drill openers for use on non-tilled ground. Curved discs may be used, although these create wider openings in the ground. In part, the intent in non-tillage seeding is to minimise the disturbance to the ground and surface, thus minimising the potential for erosion and maintaining the moisture content and nutrient levels of the soil. Therefore a thin narrow incision, such as may be obtained by drawing a substantially vertically oriented substantially flat disc in a straight line through the soil, may provide an advantage in reducing the amount of disturbance to the ground.

Each ground-penetrating element may include one or more discs, or a combination of one or more discs with one or more blades. One such combination for use in non-tillage operations includes a flat disc as described above, with one or more side blades configured to contact the disc. This arrangement can be used to clear stubble and other surface debris from the side of the disc, as well as to create a contoured incision which may be used to advantage, for example to allow the sowing of seeds at one level and the deposition of fertiliser at another.

In other non-tillage applications a coulter may be used to cut surface stubble and partially open the soil ahead of the seed drill opener. A coulter, which is a type of ground-penetrating element, is typically a broad disc or combination of discs, often with a sharp, fluted circumference.

Drawing a coulter through the soil ahead of the seed drill opener has the effect of loosening the soil in a limited channel (partial tillage) ahead of the ground-penetrating element of the seed drill opener. However, use of a coulter will normally result in greater ground disturbance than use of the flat disc ground-penetrating element described above.

In a preferred embodiment of the current invention the ground-opening device can deliver seeds. For example the ground-penetrating element may have a seed delivery tube associated with it such that a seed can be deposited at a consistent position relative to the disc.

In a preferred embodiment of the current invention the ground-opening device can deliver fertiliser. As for the seed tube described above, the ground-penetrating element may have a fertiliser delivery tube associated with it such that fertiliser can be deposited at a consistent position (normally near but not at the position of the seed delivery position) relative to the disc.

Considerable force is required to drive a ground-penetrating element, such as a disc and side blade, into non-tilled ground. The amount of force required depends on the resistance of the soil and on the desired depth of penetration. Less force is required for tilled land as the tillage process loosens the soil.

In non-tillage operation a force of up to 5000 N is required to force a normal sized disc to seeding depth in hard ground.

Commercial seed drill openers generally have a number of discs on each frame. Hence, for example, a seed drill opener having 20 discs will require around 100,000 N of force to provide full penetration of all discs into non-tilled soil.

The required downward force can be achieved in part by the weight of the seed drill opener itself. The seed drill opener normally has a heavy rigid frame to which the discs are attached. The seed drill opener may also include a seed bin or hopper.

Force derived from the weight of the frame must be applied to achieve correct operation of the seed drill opener. This downward force, which is transferred to the ground-penetrating elements, is provided by a down drive element.

Reference to a down drive element throughout this specification should be understood to refer to any device which applies a downward force directly or indirectly onto a ground-penetrating element.

In the most basic application the down drive element may be provided by placing additional weights onto the seed drill opener until the necessary penetration is achieved. This arrangement however does not allow for any adjustment of the downward force and therefore cannot be used (easily) to modify the downward force in response to changes in the soil condition.

In a preferred embodiment of the current invention the down drive element includes a hydraulic ram.

Reference to a hydraulic ram throughout this specification should be understood to mean any device that regulates and uses hydraulic pressure to transmit or apply a force to an object.

In alternate embodiments the down drive element may include a pneumatic ram, a spring or a resilient buffer, or any combination of these. Springs and/or resilient buffers may be used with hydraulic rams in order to transmit the forces from the hydraulic rams to the ground-penetrating elements.

Reference will be made throughout this specification to a down drive element as including a hydraulic ram. However, those skilled in the art will be aware that there are numerous forms of down drive elements that could be included (either alone or in combination with a hydraulic ram), such as pneumatic rams, springs and buffers, and that reference to the down drive element as including a hydraulic ram only should not be seen as limiting.

In a preferred embodiment of the invention each ground-penetrating element is individually connected to a hydraulic ram.

The source of oil pressure is common to each hydraulic ram and is typically derived from an agricultural tractor of other vehicle used to pull the seed drill opener along. The oil pressure system may operate in common with one or more pressure accumulators. The accumulators provide volumetric changes and cushioning that allows the ground-penetrating elements to rise and fall as they follow variations in the height of the soil surface without significantly changing the overall hydraulic pressure of the oil.

In alternate embodiments a number of ground-penetrating elements may be connected together on a rigid frame, with the frame having an individual connection to the hydraulic ram. In this way the same down force can be applied to a number of discs at the same time. This arrangement is simpler than having each disc connected directly to the hydraulic pressure regulator device, and therefore more economical to make.

The seed drill opener is typically attached to a tractor having a hydraulic ram. In use a downward force is applied by the hydraulic ram individually to each disc on the seed drill opener until the disc penetrates the ground to the required depth.

The resistive upward forces of the soil oppose penetration of the ground by the ground-penetrating element. Therefore a force greater than the resistive forces of the soil must be applied by the hydraulic ram to the seed drill opener in order for the seed drill opener to penetrate into the ground.

The seed drill opener usually includes a penetration-limiting device.

Reference to a penetration-limiting device throughout this specification should be understood to be any device attached to the frame of the ground-opening machine, or to the ground-penetrating element, which: is configured to reside on the surface of the ground without penetrating into it.

The position of the penetration-limiting device is adjusted so that when it is in contact with the ground the ground-penetration element will be at the desired penetration depth.

Preferably the penetration-limiting device is a gauge wheel, attached to the disc or the rigid frame to which the disc is attached.

Other forms of penetration-limiting devices such as skids or plates could be used and reference to a penetration-limiting device as a gauge wheel only throughout this specification should not be seen as limiting.

An advantage of using a gauge wheel, rather than a skid or plate, is that the gauge wheel creates less rolling resistance when drawn across the ground, placing less load on the tractor transmission.

The gauge wheel is preset to a fixed position relative to the disc such that the disc will be at the correct depth when the gauge wheel is touching the surface of the ground.

In operation the hydraulic ram applies a down force to the disc so that it penetrates into the ground until the gauge wheel is located on the surface of the ground. It is then normal practice to apply an additional load, through the hydraulic ram, to the disc.

The gauge wheel prevents the disc from penetrating deeper into the soil. The purpose of the additional load is to enable the disc to compensate for any minor variations in the resistive forces exerted by the soil.

The loading on the gauge wheel is defined as the ground reaction force. Thus the ground reaction force is zero until the gauge wheel is in contact with the surface.

The ground reaction force is initially set by the operator who selects an excess force to apply to the disc so as to keep it at the required depth under the given conditions.

As the depth of penetration of the disc is fixed by the action of the gauge wheel, the additional force becomes a load on the gauge wheel that is equal in magnitude to the upward force exerted by the ground on the gauge wheel.

The ground reaction force is not equal to (and generally much less than) the sum of the resistive forces of the soil that are overcome in penetrating the soil with the disc.

The ground reaction force will alter depending on the soil conditions encountered by the disc. For example, if the soil becomes more compacted (denser) the resistive forces of the soil will increase pushing the disc toward the surface. This will reduce the magnitude of the ground reaction force (which is the difference between the downward force applied by the hydraulic ram and the sum of the resistive forces of the soil).

In an extreme case the ground reaction force could reduce to zero, indicating that the gauge wheel is no longer in contact with the ground, and as a consequence the disc is no longer at the correct depth. It is therefore of considerable advantage to know the magnitude of the ground reaction force at all times.

The ground-opening machine includes a reaction force sensor configured to sense the ground reaction force in response to the action of the ground-penetrating element.

Reference to a ground reaction force sensor throughout this specification should be understood to refer to any apparatus or device that is configured to measure the ground reaction force.

In a preferred embodiment of the current invention the reaction force sensor includes an electronic stain gauge.

In alternative embodiments the ground reaction force sensor may include an hydraulic pressure sensor or a pneumatic pressure sensor.

Reference will be made throughout this specification to a ground reaction force sensor including an electronic strain gauge. However, those skilled in the art will be aware that other forms of reaction force sensors could be included, such as hydraulic or pneumatic pressure sensors, or mechanical sensors, and that reference to a reaction force sensor including an electronic strain gauge only should not be seen as limiting.

Typically the ground reaction force sensor involves electronic strain gauges mounted on or in a block that comes under strain as the upthrust changes. The electronic strain gauge produces a voltage in proportion to the measured strain. This voltage may be used to determine the amount of force to be applied to the seed drill in order to maintain the ground reaction force at or near a pre-set level.

Information regarding the sensed ground reaction force, typically in the form of a voltage, the magnitude of which is proportional to the ground reaction force or to a change in that force, is transmitted to a controller.

Reference to a controller throughout this specification should be understood to refer to a device or person used to regulate a function of the ground-opening device. In particular the controller is configured to adjust the down force on the ground-penetrating element in response to the sensed ground reaction force.

In a preferred embodiment of the current invention the controller includes an automated electronic device configured to receive a signal proportional to the sensed reaction force from the reaction force sensor and to adjust the down force on the ground-penetrating element in response to the received signal.

In an alternate embodiment the controller includes an hydraulic actuator which is connected to the reaction force sensor which includes an hydraulic pressure sensor. The controller is configured to adjust the down force on the ground-penetrating element in response to the sensed pressure.

In yet another alternate embodiment of the current invention the controller is an operator who manually adjusts the down force on the ground-penetrating element in response to the sensed ground reaction force. This may be indicated by various means, for example a display on a monitor, a pressure gauge or an audio signal, or combinations of these among others.

Reference is made throughout this specification to a controller as an automated electronic controller configured to receive a signal from a reaction force sensor and to adjust the down force on the ground-penetrating element in response to the signal. However, those skilled in the art will know that other forms of controller may be used, including an operator, and that reference to a controller as including an automated electronic device only should not be seen as limiting.

An advantage of using an electronic strain gauge to sense the ground reaction force is that the electronic strain gauge output is in the form of an electronic signal which is proportional to the sensed load or a change in it. This signal can be processed electronically and additional information obtained from the analysis.

For example, if the sensed ground reaction force is changing rapidly or erratically it may be appropriate for the controller to adjust the down force based on a time-averaged or smoothed value of the sensed response, or introduce some hysteresis into the reaction.

In a preferred embodiment of the current invention the controller adjusts the downward force on the ground-penetrating element in response to the sensed ground reaction force such that the reaction force of the penetration-limiting device is kept substantially constant at the preset level. In this manner the correct depth of penetration, and hence seeding, will be maintained

The ground opening device of the current Invention includes a ground reaction force sensor to measure changes in the resistive forces encountered by the ground penetrating element. Information from the sensor is transmitted to the controller where the information is processed and used to adjust the force on the ground penetrating element so as to compensate for the change in resistive forces. In this manner substantially the same ground reaction force is maintained on the gauge wheel at all times, thus ensuring the desired penetration depth for sowing the seed.

In a preferred embodiment of the current invention the ground reaction sensor and controller can be disabled. For example, the feedback should not be used when the ground penetrating disc is lifted from the soil during turning or transport, or if the gauge wheel is lifted for any reason other than when in use.

Seed drills using the current invention are provided with a major advantage over other devices which do not measure the ground reaction force and therefore have no way of knowing how the resistive forces are changing, nor the effect this may be having on the sowing depth.

Seed drills using the present invention may adjust the load on the seed drill so as to maintain it at or near a pre-determined value. The pre-determined value of the ground reaction force on the gauge wheel is chosen to provide the desired depth of penetration of the seed drill for the prevailing conditions. The use of the present invention provides the advantage of continual monitoring of the ground force reaction on the gauge wheel and adjustment of it in order to maintain the correct penetration under changing soil conditions. In this way seed planted using seed drills equipped with the present invention will be at a consistent depth thus helping to ensure uniform germination and plant emergence. This is of major economic value to the farmer as all plants in the crop grow consistently and can be treated as required at the same time.

The use of the current invention provides the greatest advantage when used in non-tilled ground, as it is these conditions that the greatest variations in resistive forces are likely to be encountered.

### BRIEF DESCRIPTION OF DRAWINGS

Further aspects of the present invention will become apparent from the following description which is given by way of example only and with reference to the accompanying drawings in which:

FIG. 1 shows a schematic of a ground-opening device; and

FIG. 2 shows a schematic of a Force Control System; and

FIG. 3 shows a schematic of another Force Control System.

### BEST MODES FOR CARRYING OUT THE INVENTION

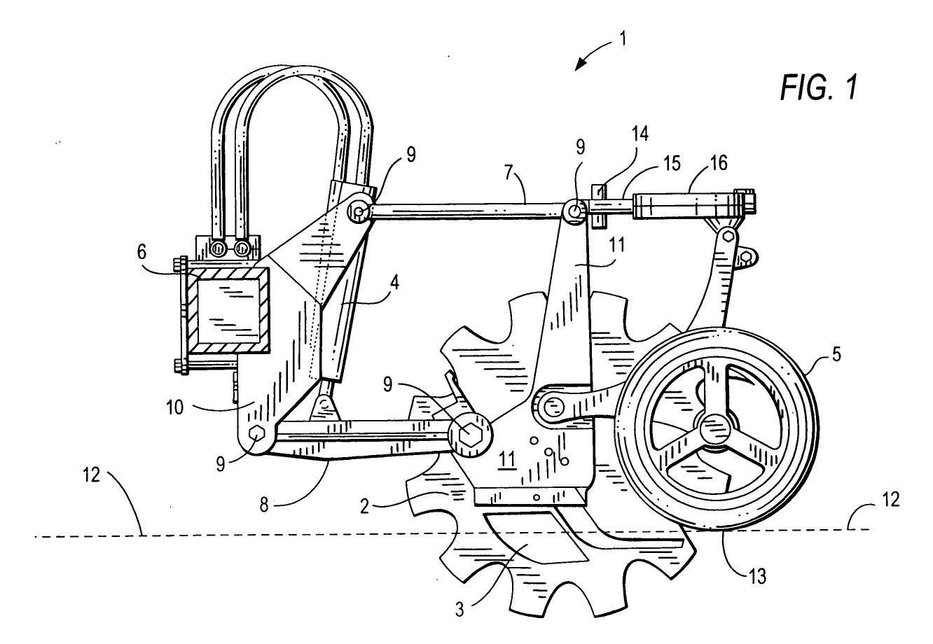

FIG. 1 shows a side view of a typical non tillage seed drill opener generally indicated by arrow 1.

The basic elements of the seed drill opener (1) consist of a ground penetrating disc (2), one or more rigid ground penetrating side blades (3), an hydraulic ram (4) and a gauge wheel (5).

The seed drill opener (1) is attached to a rigid frame (6) that is attached to a tractor (not shown). The arms (7) and (8) are attached pivotally at points (9) at each end of the arms, one end of each arm to the rigid frame mounting plate (10) and the other end of each arm to the rigid frame (11) onto which the ground penetrating disc (2) is attached.

An hydraulic ram (4) attached to the lower pivoting arm (8) is used to exert a down force that causes the disc (2) and side blades (3) to penetrate beneath the surface (12) of the ground.

At a certain hydraulic pressure the hydraulic ram (4) will not only cause the disc (2) and side blades (3) to penetrate beneath the surface (12), but will also cause the gauge wheel (5) to press upon the ground surface (12).

The configuration of the gauge wheel (5) is such that it will not normally penetrate the ground but will press upon its surface (12).

The magnitude of the force exerted by the gauge wheel (on the ground surface) is equal and opposite to the up-thrust force (13) from the ground.

The magnitude of the up-thrust (13) is measured by a ground reaction force sensor (14) located in an appropriate component of the mounting bracket (15) for the gauge wheel (5). In the example shown in FIG. 1, the mounting bracket (15) also has an adjustable component (16) that facilitates alterations in depth of sowing by altering the position of the gauge wheel (5) relative to the position of the side blades (3) which are the devices that implant the seed and fertiliser in the soil.

The system will remain in equilibrium until the soil's resistance to penetration changes. This may occur due to a change in the composition of the soil, the compaction of the soil, or the moisture content of the soil. Other factors may also influence the resistance to penetration, such as the speed at which the disc is drawn through the soil.

Any change in soil resistance is first registered as a change in the magnitude of the up-thrust force (13) exerted by the soil on the gauge wheel (5) and recorded by the ground reaction force sensor (14).

Typically the ground reaction force sensor (14) includes one or more electronic strain gauges mounted on or in a metallic block that come under strain as the up-thrust (13) changes. The strain gauge produces a voltage proportional to the strain. This output is sent via cables to a controller (17) on the machine or tractor.

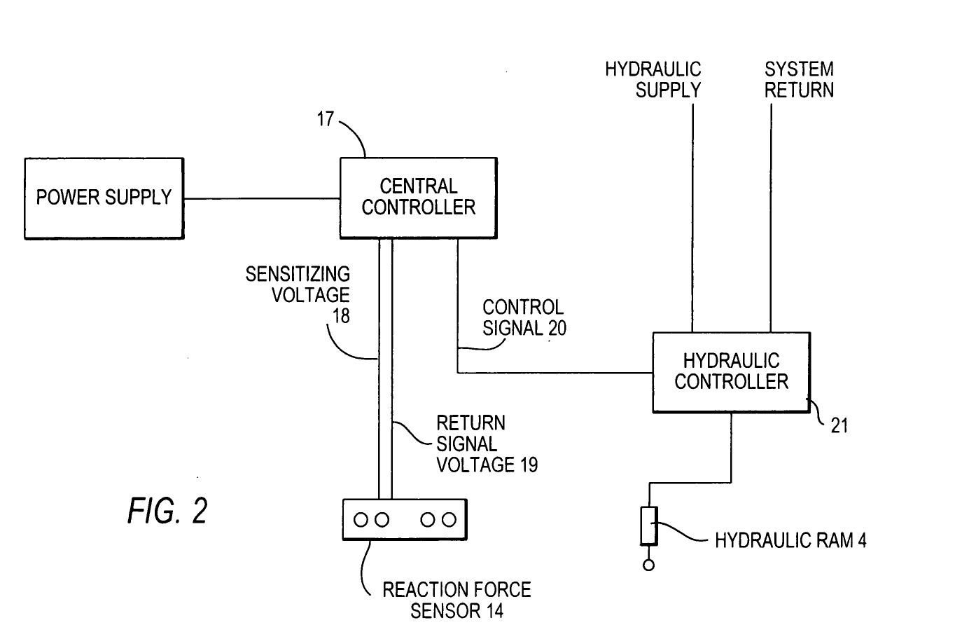

FIG. 2 shows a schematic outline of a typical force control system as used with the present invention. A continuous small sensitising voltage (18) is sent from a controller (17), typically located in the tractor cab, in order to sensitise the ground reaction force sensor (14). The sensitising voltage (18) is sent several times per second. The return signal voltage (19) from the ground reaction sensor (14) is a measure of the magnitude of strain (load) that the ground reaction force sensor (14) is experiencing at that particular point in time. The sensitising voltage (18) and return signal voltage (19) are transported from and to the controller (17) and the ground reaction force sensor (14) via insulated electrical cables.

The controller (17) averages and filters the electrical information received from the return signal voltage (19) several times per second. When the return signal voltage (19) differs (within pre-set sensitivity limits) from the pre-set values that the operator has set for the controller (17) for the field conditions in which the drill is operating, the controller (17) sends separate electrical control signals (20) via other electrical cables, to electro-hydraulic solenoids in a hydraulic controller (21) mounted on the tractor or on the drill.

The electro-hydraulic solenoids in the hydraulic controller (21) are able to draw “instant” oil under pressure (or alternatively return oil to) the tractor's internal hydraulic system or from a separate closed circuit hydraulic system operating remotely from the tractor.

The electro-hydraulic solenoids are opened and closed in order to increase or decrease the pressure of the hydraulic oil in the hydraulic ram (shown as 4 in FIG. 1) and thus increase or decrease the down force applied to the disc (shown as 2 in FIG. 1) and blades (shown as 3 in FIG. 1) that penetrate the soil, so as to return the up-thrust (shown as 13 in FIG. 1) to its pre-selected value as chosen by the operator.

Typically in a field situation, the up-thrust (13 in FIG. 1) is checked and the down force is reset if necessary approximately every metre of forward travel of the drill, although faster or slower sensitivity is also possible.

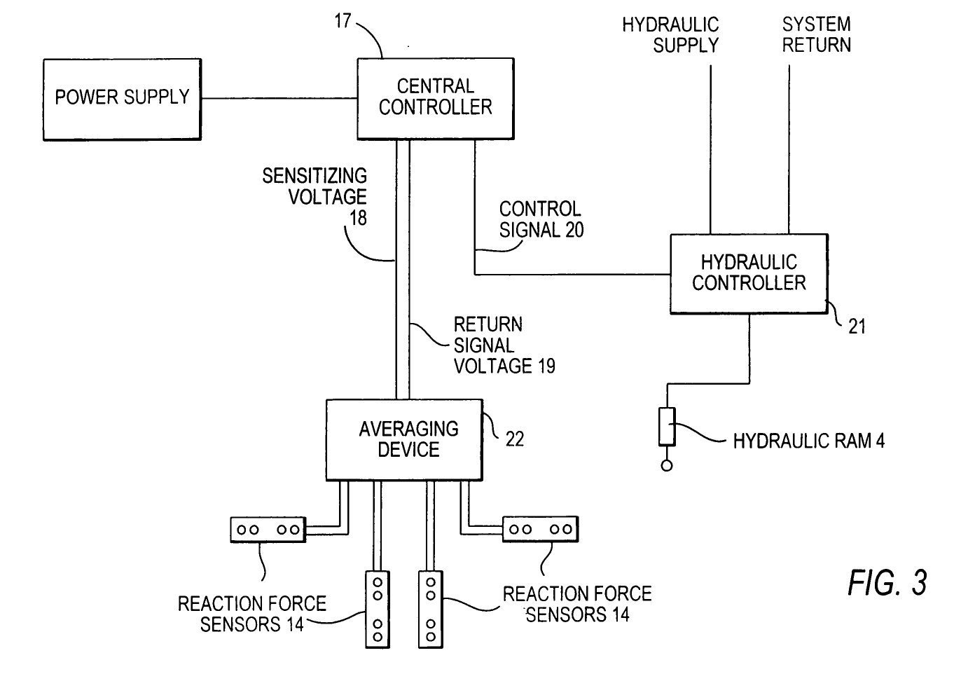

On larger machines multiple ground reaction force sensors (14) are positioned across a seed drill. A schematic of a typical force control system for multiple reaction force sensors (14) is shown in FIG. 3. A separate averaging device (22) blends and averages the signals from these multiple ground reaction force sensors (14) so that a single average return signal voltage (19) is sent to the controller (17) and processed substantially as described above. The frequency of load sensing in hydraulic control of the down force is adjustable at any time by the operator.

In rough ground conditions that might otherwise cause the return signal voltage (19) to change excessively, the sensitivity of the controller (17) can be decreased. Alternatively, the system may be deactivated altogether in rough ground conditions, stony soils and when the openers are carried clear of the ground for transport purposes.

Aspects of the present invention have been described by way of example only and it should be appreciated that modifications and additions may be made thereto without departing from the scope thereof.

What I/We claim is:

1. A ground opening device which includes,
a ground-penetrating element configured to penetrate a ground surface,
a down drive element configured to apply a downward force to the ground-penetrating element,
a reaction force sensor configured to sense a ground reaction force in response to the action of the ground-penetrating element,
characterised in that
the ground opening device includes a controller configured to adjust the downward force on the ground-penetrating element in response to the sensed ground reaction force.

2. The ground opening device of claim 1 wherein the ground opening device is a seed drill opener.

3. The ground opening device of claim 1 wherein the reaction force sensor senses the load on a gauge wheel.

4. The ground opening device of claim 1 wherein the reaction force sensor is an electronic strain gauge.

5. The ground opening device of claim 1 wherein the controller adjusts the downward force on the ground-penetrating element in response to the sensed ground reaction force such that the reaction force of the ground limiting device is kept substantially constant at a preset level.

6. A method of controlling a ground opening device having a ground-penetrating element, a down drive element, a ground reaction force sensor and a controller,
characterised by the steps of
a) applying a downward force to the ground-penetrating element using the down drive element, and
b) sensing a ground reaction force using the ground reaction force sensor; and
c) using the controller to adjust the downward force of the ground-penetrating element in response to the sensed ground reaction force.
